(19) United States
(12) Patent Application Publication
(10) Pub. No.: US 2015/0262128 A1
(43) Pub. Date: Sep. 17, 2015

(54) ASSIMILATING BUSINESS RULES

(71) Applicant: HEWLETT-PACKARD DEVELOPMENT COMPANY, L.P., Houston, TX (US)

(72) Inventors: Adi Kidron, Tel Aviv (IL); Harel Oshri, Hagor (IL); Talia Lavie, Yehud (IL); Oded Judelman, Yehud (IL); Noy Bar, Meitar (IL)

(21) Appl. No.: 14/441,424

(22) PCT Filed: Nov. 12, 2012
(86) PCT No.: PCT/US12/64631

§ 371 Date: May 7, 2015

(51) Int. Cl. G06Q 10/10; G06F 3/0481

(52) U.S. Cl. CPC G06Q 10/10; G06F 3/04817

(57) ABSTRACT

Methods, systems, and machine-readable and executable instructions are provided for assimilating business rules. Assimilating business rules can include storing a definition of a business rule based on a policy for an operation as a set of instructions in a machine readable medium. Assimilating business rules can include receiving an input regarding the operation and causing a display of the business rule as textual language within a graphical user interface in response to the input.

### BACKGROUND

Business rules may be defined by or relate to organizational policies that may govern various aspects of organizations. For example, the organizations may employ business rules relating to processing of organization data. Accordingly, business rules may provide controls on who can access the organization data and/or what interaction those accessing the organization data can have with the organizational data.

### BRIEF DESCRIPTION OF THE DRAWINGS

FIG. 1 illustrates a flow chart of an example of a method for assimilating business rules according to the present disclosure.

FIG. 2 illustrates an example of a graphical user interface in which various examples of the present disclosure may be implemented.

FIG. 3 illustrates a diagram of an example of a computing device according to the present disclosure.

### DETAILED DESCRIPTION

Assimilating business rules can be utilized to inform an individual (e.g., an employee) of an existence and/or a subject matter of a number of business rules, for instance, by causing a display of textual language representing the number of business rules to the individual via a graphical user interface following an input by the individual. With increasing pressure on organizations to improve performance, the organizations may seek to increase efficiencies, for instance, by pursuing efficient employee education of governing business rules and/or policies.

Some previous techniques for conveying business rules to individuals (e.g., employees) may rely upon manuals and/or tutorials. However, conveying business rules to individuals through manuals and/or tutorials has proven to be complex and/or costly. That is, individuals may not fully examine (e.g., read) and/or may not fully understand such a manual or tutorial. Additionally, subject matter contained in the manual and/or tutorial may need to be updated to correspond to evolving business rules and/or policies and such updates may need to be communicated to the individuals governed by the business rules and/or policies. Such updates to the subject matter and/or resulting communications can be time consuming and/or costly.

In contrast, examples of the present disclosure include methods, systems, and machine-readable and executable instructions for assimilating business rules, as described herein. An example of a method for assimilating business rules includes storing a definition of a business rule based on a policy for an operation as a set of instructions in a machine readable medium. In various examples, an input regarding the operation can be received and the business rule can be displayed as textual language within a graphical user interface in response to the input.

Such assimilated business rules can be used to notify an individual of an existence of a specific business rule, a subject matter of the business rule, and/or a corresponding indication of authorization (e.g., for a given business rule) for the given individual; among other notifications. For example, the business rule can be displayed as textual language within a graphical user interface in response to an input, as described herein. Advantageously, this can enable consistent education of individuals related to the number of business rules and/or policies governing the individuals. Additional advantages can be realized by receiving feedback on the number of business rules and/or policies, as described herein. For example, the number of business rules can be changed based upon such feedback. Such a change can enable dynamic updating of the number of business rules and/or policies that can affect individuals (e.g., real users).

In the following detailed description of the present disclosure, reference is made to the accompanying drawings that form a part hereof, and in which is shown by way of illustration how examples of the disclosure can be practiced. These examples are described in sufficient detail to enable those of ordinary skill in the art to practice the examples of this disclosure, and it is to be understood that other examples can be utilized and that process; electrical, and/or structural changes can be made without departing from the scope of the present disclosure.

As will be appreciated, elements shown in the various examples herein can be added, exchanged; and/or eliminated so as to provide a number of additional examples of the present disclosure. In addition, the proportion and the relative scale of the elements provided in the figures are intended to illustrate the examples of the present disclosure, and should not be taken in a limiting sense. As used herein, “a number of” an element and/or feature can refer to one or more of such elements and/or features. In addition, “for example” and similar phrasing is intended to mean, “by way of example and not by way of limitation”

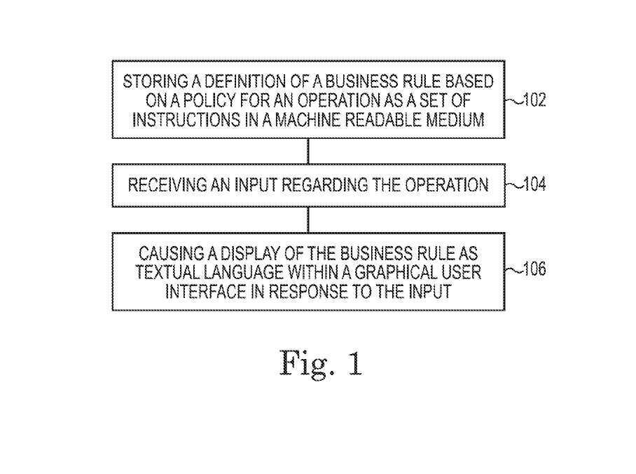

FIG. 1 illustrates a flow chart of an example of a method for assimilating business rules according to the present disclosure. At block 102, the method can include storing a definition of a business rule based on a policy for an operation as a set of instructions in a machine readable medium. Storing can include executing instructions stored in memory to store a definition of a business rule based on a policy for an operation as a set of instructions in a machine readable medium. Additionally, at block 104, the method can include receiving an input regarding the operation. Further, at block 106, the method can include causing a display of the business rule as textual language within a graphical user interface in response to the input.

As described herein, a “policy” represents guidelines that can govern procedures, for example, organizational procedures, communication procedures, data input procedures, and/or analysis procedures, among other procedures that the guidelines can govern. For instance, the policy (e.g., an organizational policy) may provide an organization procedure governing a number of business units that can access a given type of organizational data. For example, a policy can specify that only specified business units of the organization that are involved in sales can have access rights to sales data (e.g., sales data for a given organizational product). Accordingly, a business rule can define such access rights, for example, access rights can be granted to the specified business units (e.g., a number of individuals in the specified business units) involved in sales. However, the present disclosure is not so limited. That is, the business rule can be based on any suitable number of policies (e.g., two policies).

As described herein, a “business rule” represents (e.g., defines) a set of criteria to be fulfilled in order to perform a given function. Such a definition of the set of criteria can include providing an authorized or unauthorized status for each of a number of operations (e.g., access rights) for a given user. That is, each of the number of operations can be either authorized or unauthorized for a given user. As described herein, an “operation” represents a function (e.g., an action) relating to the organizational data that can be performed by a machine (e.g., a computer). Examples of the number of operations include accessing, copying, moving, deleting, and/or altering organizational data, among other functions. In some examples, the number of operations can be selected by a user, for example, by selection of an icon via the graphical display, as described herein. An authorized operation represents an operation of the number of operations that a given user can enable the computer to perform. An unauthorized operation represents an operation of the number of operations that a given user can not enable the computer to perform (e.g., the given user does not have sufficient access rights to enable to the computer to perform).

In some examples, the number of business rules can include a permission rule, a process rule, and/or an access-time rule, among other types of business rules. A permission rule can represent a business rule defining user permissions. Such permissions can include access permissions (e.g., whether a given user can access a particular data element of the organizational data) and/or access type permissions (e.g., whether a given user can have read/write access for a particular data element). A process rule can represent a business rule defining process constraints. Process constraints (e.g. a process limitation) can include hierarchal constraints (e.g., action X may be performed prior to enabling performing of action Y), threshold constraints (e.g., a maximum number of operations that can be performed at any given time), among other constraints. An access-time rule can represent a business rule defining what time(s) a given user can access a particular data element of the organizational data and/or perform an operation of the number of operations. For example, an access-time rule can provide that a given user can perform an operation during normal business operating hours (e.g., during daytime). Alternatively or in addition, an access-time rule can provide that a given operation can define a time(s) for the given action to be performed. For instance, an operation for a particular project can be disabled upon completion of specified milestone(s) for the particular project.

At block 104, the method can include receiving an input regarding the operation. Receiving can include executing instructions stored in memory to receive an input regarding the operation. The input can include numeric, alphabetic, and/or alpha-numeric inputs. The inputs can be provided via a keyboard, mouse, touch-screen, audio input device, among other suitable input devices to provide the input. In some examples, receiving the input can include receiving the input from a user that is unauthorized for the operation according to the business rule. For example, a user can select an operation in the graphical user interface that the user is unable to perform (e.g., deleting a given data element of the organizational data).

At block 106, the method can include causing a display of the business rule as textual language within a graphical user interface in response to the input. Displaying can include executing instructions stored in memory to display the business rule as textual language within a graphical user interface in response to the input. Causing can include executing instruction stored in memory to directly cause a graphical user interface to display the business rule as textual language and/or to communicate data with an expectation that it be processed by another device to cause the display of the business rule as textual language.

As described herein, displaying textual language can refer to displaying text (e.g., human readable text) representing a type of the business rule, the subject matter of the business rule, and/or a derivative of the subject matter of the business rule, among other attributes corresponding to the business rule, without displaying any portion of the program code (e.g., native code) for the business rule. That is, the type (e.g., a permission rule) of the business rule, the subject matter business rule, and/or the derivative of the business rule can be displayed, for example, via the graphical user interface.

Alternatively or in addition, in some examples, causing a display of the business rule can include causing a display of a dependency of the business rule on another business rule. In some examples, such a dependency can be displayed as textual language. For example, “action Y needs to be performed prior to performing action X”. Accordingly, the displayed textual language can include a display of the subject matter (e.g., action Y needs to be performed prior to performing action X) and/or a derivative of the subject matter, for example, “you cannot perform action X”. Hence, in some examples, where the user selects an operation the user is unauthorized to perform this can result in a causing a display of a business rule (e.g., a display of textual language) notifying the user of such a dependency. Alternatively or in addition, in some examples, such a dependency can be displayed via a hierarchal data tree (e.g., action Y above action X in a data tree to indicate action Y need be performed prior to action X), and/or via a dependency graph.

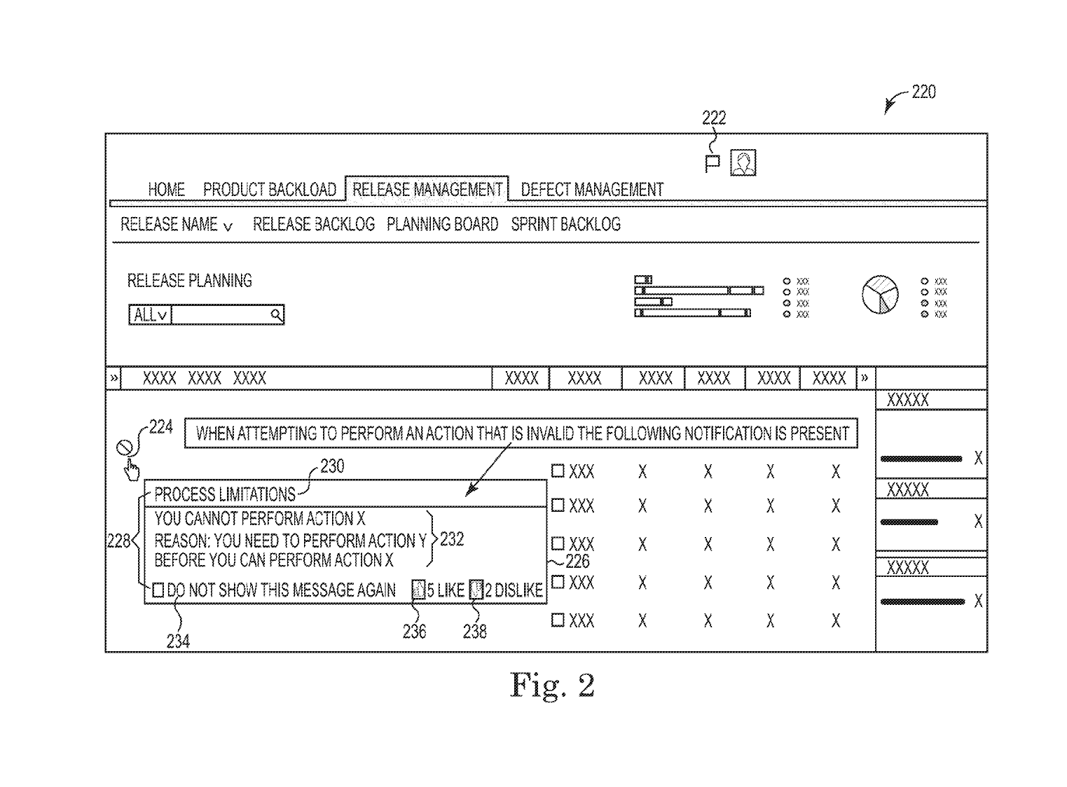

In some examples, receiving the input can include receiving a selection of an icon displayed within the graphical user interface. The icon can be a selectable-We (e.g., a flag), a hyperlink, and/or a drop-down menu, among others suitable to receive the input. In some examples, the icon can be a flag (e.g., 222 as shown in FIG. 2) displayed within the graphical user interface. In some examples, selection of the icon can result in causing a display of a number of operations as textual language, where each of the number of operations can be either authorized or unauthorized (e.g., authorized or unauthorized operations for a given user).

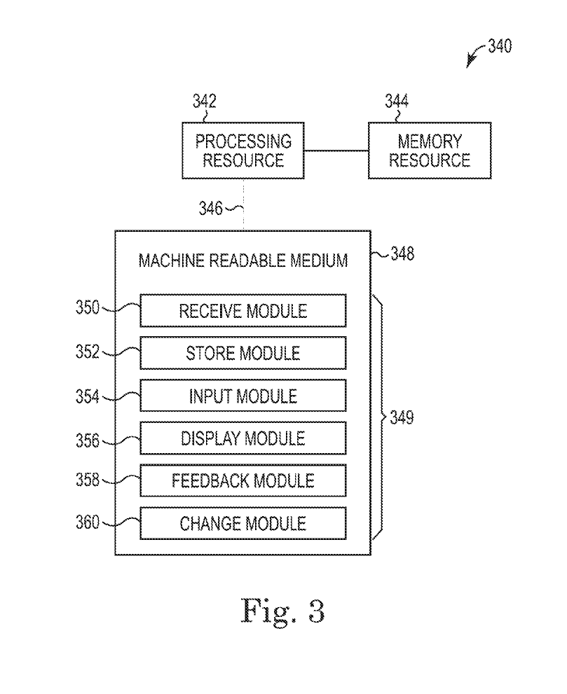

FIG. 2 illustrates an example of a graphical user interface in which various examples of the present disclosure may be implemented. As illustrated in FIG. 2, an input (e.g., a mouse click) can be received for an operation 224 that is unauthorized based upon a corresponding business rule. The business rule can be stored in memory resources (e.g., 344 as described with respect to FIG. 3) as program code). Examples of the program code include C++, C#, and/or JavaScript, among other suitable types of program code.

In response to the input, the business rule can be displayed, for example, in a text box 226 as textual language 228 (e.g., embedded textual language) within the graphical user interface 220. The textual language 228 can include text corresponding to the type (e.g., 230) and/or the subject matter (e.g., 232) of the business rule, among other text corresponding to attributes of the business rule. In some examples, the text box 226 can include an option to not display the business rule again 234 (e.g., not display the business rule upon additional inputs corresponding to the business rule). Alternatively or in addition, the textual language can include a dependency of the rule on another business rule, as described herein.

In some examples, the graphical user interface 220 can be included in a management application (e.g., an Enterprise software application). The management application can reside on a management server, and the management application can be enable a user to manage aspects of the network environment. The management server can be a web server, a client server, mainframe, a cloud server, or another type of application server.

Examples of the aspects of the networked environment can include network nodes or devices that can be managed though the network management application, such as: routers, switches, Internet protocol (IP) phones, networked printers, or other devices on a network that can communicate via management protocols such as Simple Network Management Protocol (SNMP). Alternatively or in addition, the network management software can manage a number of business services and/or corresponding organizational data. The structures or the models of a number of business services, and their relationships with the networked environment, can be stored, for example, in a configuration management database (CMDB).

Accordingly, the network management application may be an enterprise network management system that allows an end user or information technology (IT) administrator to manage computer networks of significant size through a substantially uniform graphical user interface (ed., graphical user interface 220 of FIG. 2). Such a uniform graphical user interface may allow the end user to use a web client or web browser on a client computer to view the business rules, provide feedback as described herein, and/or and make changes as described herein. Using a substantially uniform graphical user interface can reduce the complexity of providing the number of operations, displaying the number of business rules, receiving feedback, and/or changing the number of business rules, among others. For example, such a substantially uniform interface can facilitate displaying the business rule as textual language within a graphical user interface in response to the input

The graphical user interface 220 can be implemented in a number of environments. Examples of the number of environments can include IBM WebSphere Application Server®, BEA WebLogic Application Server®, Microsoft.NET®, IBM mainframe CICS (Customer Information Control System)®, IBM mainframe Information Management System (IMS), IBM WebSphere MQ®, TIBCO EMS®, and SONIC MQ® asynchronous messaging environment running on IBM mainframe zOS platform, various Unix®, and Microsoft Windows® platforms, among others.

In some examples, the graphical user interface 220 can display a plurality of indicators 236, 238 corresponding to the business rule. The plurality of indicators 236, 238 can provide a mechanism for a user to input feedback regarding the business rule and/or the policy. For example, the plurality of indicators 236, 238 can include a like indicator 236 and/or a dislike indicator 238 to enable a user to input feedback for the business rule.

Alternatively or in addition, in some examples feedback can include a plurality of feedback options (not shown) corresponding to the number of business rules, the number of policies, and/or the plurality of indicators (e.g., 236 and/or 238). For instance, a plurality of feedback options relating to the dislike indicator 238 can be displayed via the graphical user interface 220. For example, a user can select the dislike indicator 238 and select a feedback option of the plurality of feedback options corresponding to the selection of the dislike indicator 238. Such feedback can provide information regarding the selection of the dislike indicator 238. For example, dissatisfaction with the amount of time relating to a given business rule (e.g., an operation governed by the business rule takes longer than desired) and/or not being able to perform a desired operation (e.g., a user that is unauthorized for the operation according to the business rule), among others.

The received feedback can be displayed within the graphical user interface as statistics as a result of the received feedback. Examples of statistics include a total number of users that encountered a given business rule, a total number of likes and/or dislikes for a given business rule, among other statistics.

In some examples, the statistics can be displayed to a given user. For instance, the statistics can be displayed to an IT administrator and/or a user that provided the input (e.g. the input corresponding to the displayed business rule), among other users. Such a display can facilitate the business rule to be changed, for example a change based upon the displayed statistics. Changing the business rule can include altering a subject matter of the business rule and/or altering at least one of the operations to which the business rule corresponds. For example, a business rule can be changed to provide a given user access rights to data the given user was previously unable to access based upon the business rule. Accordingly, in some examples, an existing business rule can be changed. Alternatively or in addition, in some examples, changing the business rule can include creating a new (e.g., substitute) business rule.

In some examples, the changed business rule can replace the previous business rule stored as a set of instruction in a machine readable medium. For example, such a change can be implemented immediately following the change, after a predetermined time following the change, and/or at a predetermined time of day. For example, a predetermined time could correspond to a time generally associated with a comparatively low number of users (e.g., during nighttime hours). The predetermined time can be a regularly scheduled time (e.g., reoccurring) and/or specified by a user (e.g., an IT administrator).

In some examples, the changed business rule can be displayed within the graphical user interface 220. Such a display can be provided to those implementing the change (e.g., an IT administrator) and/or users governed by the changed business rule (e.g., a number of users governed by the business rule). Such a display can be provided, for example, as a notification. The notification can be communicated by an email and/or by prompting a given user via the graphical user interface 220, among others. Such a notification can occur at the time the change is made, after a predetermined amount of time following the change, and/or upon receiving an input regarding an operation governed by the business rule (e.g., the changed business rule).

FIG. 3 illustrates a diagram of an example of a computing device 340 according to the present disclosure. The computing device 340 can utilize software, hardware, firmware, and/or logic to provide a simulated network including a number of network parameters.

The computing device 340 can be any combination of hardware and program instructions configured for assimilating business rules. The hardware, for example can include one or more processing resources 342, memory resources 344, and/or machine readable medium (MRM) 348 (e.g., computer readable medium (CRM), database, etc.). The program instructions (e.g., machine-readable instructions (MRI) 349) can include instructions stored on the MRM 348 and executable by the processing resources 342 to implement a desired function (e.g., receive a definition of a business rule based on a policy for an operation, store the business rule, receive an input regarding the operation, and/or display the business rule as textual language within a graphical user interface 220 in response to the input, etc.).

MRM 348 can be in communication with a number of processing resources of more or fewer than 342. The processing resources 342 can be in communication with a tangible non-transitory MRM 348 storing a set of MRI 349 executable by the processing resources 342, as described herein. The MRI 349 can also be stored in remote memory managed by a server and represent an installation package that can be downloaded, installed, and executed. The computing device 340 can include memory resources 344, and the processing resources 342 can be coupled to the memory resources 344.

Processing resources 342 can execute MRI 349 that can be stored on an internal or external non-transitory MRM 348. The processing resources 342 can execute MRI 349 to perform various functions, including the functions described in FIG. 1 and FIG. 2. For example, the processing resources 342 can execute MRI 349 to assimilate business rules.

The MRI 349 can include a number of modules 350, 352, 354, 356, 358, and 360. The number of modules 350, 352, 354, 356, 358, and 360 can include MRI 349 that when executed by the processing resources 342 can perform a number of functions including the functions described in FIG. 1 and FIG. 2.

The number of modules 350, 352, 354, 356, 358, and 360 can be sub-modules of other modules. For example, a receive module 350 and a store module 352 can be sub-modules and/or contained within the same computing device (e.g., computing device 340). In another example, the number of modules 350, 352, 354, 356, 358, and 360 can comprise individual modules on separate and distinct computing devices.

The receive module 350 can include MRI that when executed by the processing resources 342 can perform a number of receiving functions. For example, the receive module 350 can receive a definition of a business rule based on a policy for an operation.

The store module 352 can include MRI that when executed by the processing resources 342 can perform a number of storing functions. The store module 352 can store the business rule. For example, the store module 352 can store the business rule obtained from the receive module 350. The store module 352 can stare business rule as a set of instructions in the MRM 348.

An input module 354 can include MRI that when executed by the processing resources 342 can perform a number of inputting functions. The input module 354 can receive an input regarding the operation. For example, the input module 354 can receive an input from a user that is unauthorized for the operation according to the business rule (e.g., stored by the store module 352) and/or receive a selection of an icon (e.g., selection of an icon displayed within the graphical user interface 220)

A display module 356 can include MRI that when executed by the processing resources 342 can perform a number of displaying functions. The display module 356 can cause the display of the business rule as textual language, for example, within a graphical user interface 220 in response to the input, as described herein.

A feedback module 358 can include MRI that when executed by the processing resources 342 can perform a number of feedback functions. The feedback module 358 can receive feedback on the business rule, as described herein. In some examples, the feedback module to cause a display of a plurality of indicators corresponding to the business rule. For example, the plurality of indicators can include a like indicator and/or a dislike indicator, among other indicators.

A change module 360 can include MRI that when executed by the processing resources 342 can perform a number of changing functions. The change module 360 can cause the display of a change to the business rule. For example, the change module 360 can cause the display of the change to the business rule within the graphical user interface 220 as a result of the feedback. In some examples, the change module can change an existing business rule, as described herein.

A non-transitory MRM 348, as used herein, can include volatile and/or non-volatile memory. Volatile memory can include memory that depends upon power to store information, such as various types of dynamic random access memory (DRAM), among others. Non-volatile memory can include memory that does not depend upon power to store information. Examples of non-volatile memory can include solid state media such as flash memory, electrically erasable programmable read-only memory (EEPROM), phase change random access memory (PCRAM), magnetic memory such as a hard disk, tape drives, and/or a solid state drive (SSD), etc., as well as other types of machine-readable media.

The non-transitory MRM 348 can be integral, or communicatively coupled, to a computing device, in a wired and/or a wireless manner. For example, the non-transitory MRM 348 can be an internal memory; a portable memory, a portable disk, or a memory associated with another computing resource (e.g., enabling MRIs to be transferred and/or executed across a network such as the Internet).

The MRM 348 can be in communication with the processing resources 342 via a communication path 346. The communication path 346 can be local or remote to a machine (e.g., a computer) associated with the processing resources 342. Examples of a local communication path 346 can include an electronic bus internal to a machine (e.g., a computer) where the MRM 348 is one of volatile, non-volatile, fixed, and/or removable storage medium in communication with the processing resources 342 via the electronic bus.

The communication path 346 can be such that the MRM 348 is remote from the processing resources (e.g., 342), such as in a network connection between the MRM 348 and the processing resources (e.g., 342). That is, the communication path 346 can be a network connection. Examples of such a network connection can include a local area network (LAN), wide area network (WAN), personal area network (PAN), and the Internet, among others. In such examples, the MRM 348 can be associated with a first computing device and the processing resources 342 can be associated with a second computing device (e.g., a Java® server). For example, a processing resource 342 can be in communication with a MRM 348, wherein the MRM 348 includes a set of instructions and wherein the processing resource 342 is designed to carry out the set of instructions.

As used herein, “logic” is an alternative or additional processing resource to execute the actions and/or functions, etc., described herein, which includes hardware (e.g., various forms of transistor logic, application specific integrated circuits (ASICs), etc.), as opposed to machine executable instructions (e.g., software, firmware, etc.) stored in memory and executable by a processor.

The specification examples provide a description of the applications and use of the system and method of the present disclosure. Since many examples can be made without departing from the spirit and scope of the system and method of the present disclosure, this specification sets forth some of the many possible example configurations and implementations.

What is claimed:

1. A method for assimilating business rules, comprising:
storing a definition of a business rule based on a policy for an operation as a set of instructions in a machine readable medium;
receiving an input regarding the operation; and
causing a display of the business rule as textual language within a graphical user interface in response to the input.

2. The method of claim 1, wherein receiving the input comprises receiving the input from a user that is unauthorized for the operation according to the business rule.

3. The method of claim 1, wherein receiving the input comprises receiving a selection of an icon displayed within the graphical user interface.

4. The method of claim 3, wherein the selection of the icon results in causing a display of a number of operations, wherein each of the number of operations are either authorized or unauthorized for a user.

5. The method of claim 1, wherein the business rule is a permission rule.

6. The method of claim 1, wherein the business rule is a process rule.

7. The method of claim 1; wherein business rule is an access-time rule.

8. The method of claim 1, wherein causing a display of the business rule comprises causing a display of a notification of changes to the business rule.

9. The method of claim 1, wherein causing a display of the business rule comprises causing a display of a dependency of the business rule on another business rule.

10. A non-transitory machine-readable medium storing instructions for assimilating business ruses executable by a processing resource to cause a computer to:
receive a definition of a business rule based on a policy for an operation;
store the business rule as a set of instructions in a machine readable medium;
receive an input regarding the operation;
cause a display of the business rule as textual language within a graphical user interface in response to the input; and
receive feedback on the business rule.

11. The non-transitory machine readable medium of claim of claim 10, wherein the instructions are executable to generate statistics as a result of the received feedback.

12. The non-transitory machine readable medium of claim of claim 11, wherein the instructions are executable to cause a display of the statistics to a user via a graphical user interface to enable the business rule to be changed based upon the displayed statistics.

13. A system for assimilating business rules, comprising:
a memory resource; and
a processing resource coupled to the memory resource to implement:
a receive module to receive a definition of a business rule based on a policy for an operation;
a store module to store the business rule as a set of instructions in a machine readable medium;
a input module to receive an input regarding the operation;
a display module to cause a display of the business rule as textual language within a graphical user interface in response to the input;
a feedback module to receive feedback on the business rule; and
a change module to cause a display of a change to the business rule within the graphical user interface as a result of the feedback.

14. The system of claim 13, wherein the processing resource is coupled to the memory resource to direct the processing resource to implement the change module to change an existing business rule.

15. The system of claim 13, wherein the processing resource is coupled to the memory resource to direct the feedback module to cause a display of a plurality of indicators corresponding to the business rule, wherein the plurality of indicators comprise a like indicator and a dislike indicator.
